(19) United States
(12) Patent Application Publication
(10) Pub. No.: US 2016/0341869 A1
(43) Pub. Date: Nov. 24, 2016

(54) LIGHT GUIDE PLATE, BACKLIGHT MODULE AND LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/423,117

(22) PCT Filed: Jan. 9, 2015
(86) PCT No.: PCT/CN2015/070480

§ 371 Date: Feb. 21, 2015

(30) Foreign Application Priority Data
Dec. 26, 2014 (CN) 201410837513.8

(51) Int. Cl. F21V 8/00

(52) U.S. Cl. CPC G02B 6/0016; G02B 6/0055; G02B 6/005

(57) ABSTRACT

A light guide plate having a light output surface is provided. The light output surface is disposed with a microstructure, and a protective structure layer is disposed overlying the microstructure, the protective structure layer and the microstructure are integrally formed in the light guide plate. The invention further provides a backlight module including a back plate, a reflective sheet disposed on the back plate, the aforementioned light guide plate disposed on the reflective sheet, a backlight source disposed at a side of the light guide plate, and an optical film set disposed on the light guide plate. Moreover, the invention provides a liquid crystal display device including the above-described backlight module.

### TECHNICAL FIELD

The present invention relates to the field of liquid crystal display technology, and particularly to a light guide plate, a backlight module and a liquid crystal display device including the backlight module.

### DESCRIPTION OF RELATED ART

Liquid crystal display (LCD) devices have the advantages of slim body, low power consumption and irradiation-free, etc., and therefore have been widely used in various applications such as mobile phones, digital cameras, computers and TV screens. Most of liquid crystal display devices in the current market are backlit type liquid crystal display devices. The backlit type liquid crystal display device generally includes a liquid crystal panel and a backlight module, the liquid crystal panel is disposed opposite to the backlight module, and the backlight module is for providing a display light source to the liquid crystal panel and thereby facilitating the liquid crystal panel to display an image. In the increasingly competitive display market, differentiation designs have become one of important research directions of manufacturers to enhance their products selling points. In the existing products, common designs have slim design and narrow border design, and such designs can get beautiful appearance to attract the attention of consumers.

The backlight module is an important part of the liquid crystal display device. FIG. 1 is a schematic structural view of a conventional backlight module. As shown in FIG. 1, the backlight module mainly includes a back plate 1, a reflective sheet 2, a light guide plate 3 and an optical film set 4 stacked in that order. A backlight source 5 is disposed at a side of the light guide plate 3. The backlight source 5 emits light rays, propagation directions of the light rays then are changed by the light guide plate 3 and the optical film set 4 and thereby the distribution of light rays is uniformized as much as possible, and fmally the light rays exit out from the top of the optical film set 4 toward a liquid crystal panel. In FIG. 1, in order to improve the light concentrating effect of the light guide plate 3, microstructures 3a generally are disposed on a light output surface of the light guide plate 3 and then the optical film set 4 is disposed on the microstructures 3a, a concrete structure of the light guide plate 3 is shown in FIG. 2. However, because the micro structures 3a each have a very small size and thus is fragile, during assembling the optical film set 4 on the microstructures 3a, the mutual friction between the microstructures 3a and the optical film set 4 would easily cause the structural damage of the microstructures 3a.

### SUMMARY

Accordingly, in order to overcome the drawbacks in the prior art, the invention provides a light guide plate, by the improvement of structure to the light guide plate, a microstructure on a light output surface of the light guide plate can be effectively protected.

In order to achieve the above objective, the invention provides the following technical solution that:

A light guide plate has a light output surface, the light output surface is disposed with a microstructure, a protective structure layer is disposed overlying the microstructure, and the protective structure layer and the microstructure are integrally formed in the light guide plate.

In an embodiment, the microstructure includes a plurality of triangular prisms.

In an embodiment, the microstructure includes a plurality of semi-cylinders.

In an embodiment, the microstructure includes a plurality of micro-bumps.

In an embodiment, a bottom portion of the protective structure layer is tightly contacted with a top portion of the microstructure.

In an embodiment, a bottom portion of the protective structure layer and a top portion of the microstructure have a gap formed therebetween.

The invention further provides a backlight module including: a back plate; a reflective sheet disposed on the back plate; the above-described light guide plate disposed on the reflective sheet; a backlight source disposed at a side of the light guide plate; and an optical film set disposed on the light guide plate.

The invention still further provides a liquid crystal display device including a liquid crystal panel and a backlight module. The liquid crystal panel and the backlight module are disposed opposite to each other. The backlight module is configured for providing a display light source to the liquid crystal panel to facilitate the liquid crystal panel to display an image. The backlight module is the aforementioned backlight module.

The efficacy of the invention is that: in the light guide plate provided any one embodiment of the invention, the light output surface of the light guide plate firstly is disposed with the microstructure and then the protective structure layer is disposed overlying the microstructure, the protective structure layer and the microstructure are integrally formed in the light guide plate. When the light guide plate is assembled into a backlight module, the optical film set and other parts disposed on the light guide plate would not directly act on the microstructure and thus can effectively prevent the abrasion of the microstructure of the light guide plate.

### BRIEF DESCRIPTION OF THE DRAWINGS

The above and other aspects, features and advantages of embodiments of the invention will be more apparent from the following detailed description taken in conjunction with the accompanying drawings, in which:

FIG. 1 is a schematic structural view of a conventional backlight module;

FIG. 2 is a schematic structural view of a light guide plate as shown in FIG. 1;

FIG. 3 is a schematic structural view of a backlight module according to an embodiment of the invention;

FIG. 4 is a cross-sectional view of a light guide plate as shown in FIG. 3;

FIG. 5 is a cross-sectional view of a light guide plate according to another embodiment of the invention;

FIG. 6 is a cross-sectional view of a light guide plate according to still another embodiment of the invention;

FIG. 7 is a top view of a light guide plate according to even still another embodiment of the invention; and

FIG. 8 is a schematic structural view of a liquid crystal display device according to an embodiment of the invention.

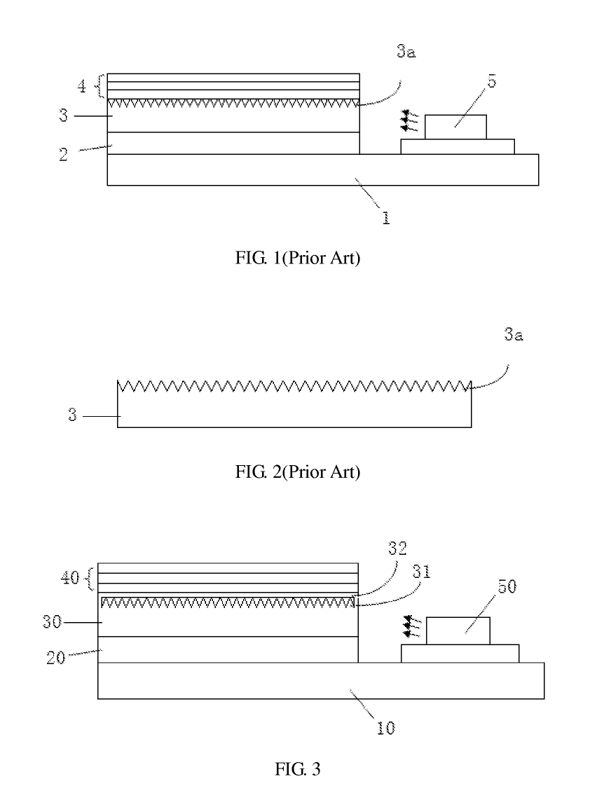

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

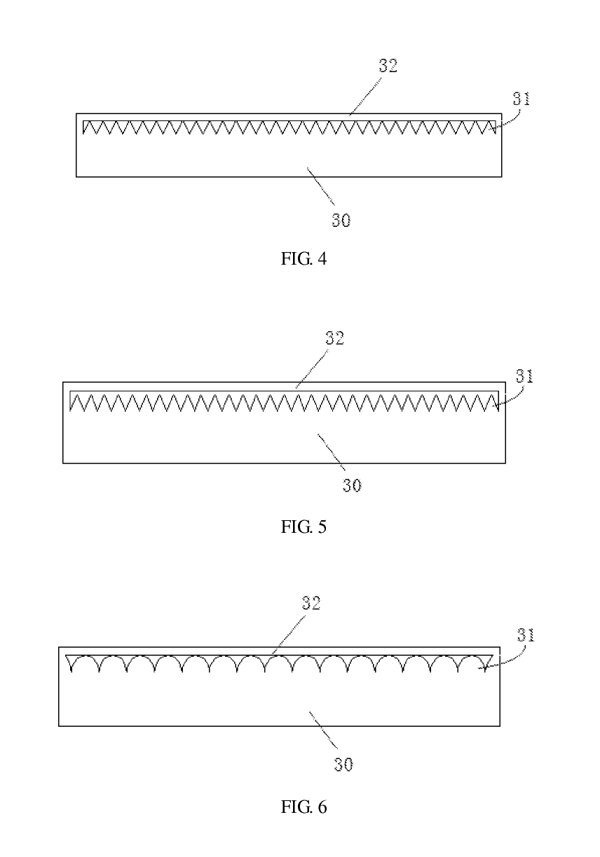

Referring to FIG. 3 and FIG. 4, as shown in FIG. 3, an embodiment of the invention firstly provides a backlight module. The backlight module at least includes a back plate 10, a reflective sheet 20 disposed on the back plate 10, a light guide plate disposed on the reflective sheet 20, a backlight source 50 disposed at a side of the light guide plate 30, and an optical film set 40 disposed on the light guide plate 30. The backlight source 50 is configured (i.e., structured and arranged) for emitting light rays, the light guide plate 30 and the optical film set 40 will change propagation directions of the light rays passing therethrough to make the light rays be uniformly distributed as much as possible, the uniformized light rays then exit out from the top of the optical film set 40 toward a liquid crystal panel.

As shown in FIG. 4, for the light guide plate 30 in the backlight module of the embodiment, in order to improve the light concentrating effect of the light guide plate 30, microstructures 31 are formed on a light output surface of the light guide plate 30 and a protective structure layer 32 is formed overlying the microstructures 31. Specifically, the protective structure layer 32 and the microstructures 31 are integrally formed in the light guide plate 30, and can be obtained by an etching process, an injection molding process or a 3D (three-dimensional) printing process. The protective structure layer 32 completely covers and overlies the microstructure 31, and therefore the optical film set 40 and other parts assembled on the light guide plate 30 would not directly contact with the microstructures 31.

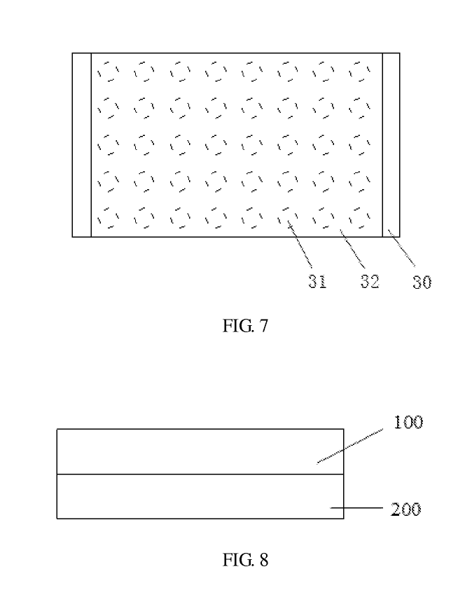

In this embodiment, as shown in FIG. 4, the microstructures 31 are a plurality of triangular prisms, the bottom portion of the protective structure layer 32 is tightly contacted with top portions of the microstructures 31. In another embodiment, as shown in FIG. 5, the bottom portion of the protective structure 32 and the top portions of the microstructures 31 can be designed to have a gap formed therebetween, i.e., the bottom portion of the protective structure 32 is spaced from the top portions of the microstructures 31 with a certain distance. In still another embodiment, as shown in FIG. 6, the microstructures 31 can be a plurality of semi-cylinders. In even still another embodiment, as shown in FIG. 7, the microstructures 31 can be a plurality of micro-bumps.

In the light guide plate as described in any one of the foregoing embodiments, the light output surface of the light guide plate firstly is disposed with the microstructures and then the protective structure layer is disposed overlying the microstructures, and moreover the protective structure layer and the microstructures are integrally formed in the light guide plate. When the light guide plate is assembled into a backlight module, the optical film set and other parts disposed on the light guide plate would not directly act on the microstructures, which can effectively prevent abrasion of the microstructures of the light guide plate.

An embodiment of the invention further provides a liquid crystal display device. As shown in FIG. 8, the liquid crystal display device includes a liquid crystal panel 100 and a backlight module 200, the liquid crystal panel 100 and the backlight module 200 are disposed opposite to each other, and the backlight module 200 is configured for providing a display light source to the liquid crystal panel 100 to facilitate the liquid crystal panel 100 to display an image. The backlight module 200 adopts the foregoing backlight module.

It is indicated that, in this specification, the relational terminologies such as “first” and “second” only are intended to discriminate an entity or operation from another entity or operation, and not necessarily to require or imply these entities or operations having actual relationships or orders existed therebetween. Moreover, the terminology of “including”, “containing” or variations thereof is meant to cover non-exclusive inclusion, so that a process, method, article or apparatus including a series of items not only includes listed items but also includes other item(s) not being explicitly listed or inherent item(s) of the process, method, article or apparatus. In the absence of more restrictive conditions, the item limited by the phraseology “including one” does not exclude the existence of additional identical item(s) in the process, method, article or apparatus including the item.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light guide plate having a light output surface, wherein the light output surface is disposed with a microstructure, a protective structure layer is disposed overlying the microstructure, the protective structure layer and the microstructure are integrally formed in the light guide plate.

2. The light guide plate as claimed in claim 1, wherein the microstructure comprises a plurality of triangular prisms.

3. The light guide plate as claimed in claim 1, wherein the microstructure comprises a plurality of semi-cylinders.

4. The light guide plate as claimed in claim 1, wherein the microstructure comprises a plurality of micro-bumps.

5. The light guide plate as claimed in claim 1, wherein a bottom portion of the protective structure layer is tightly contacted with a top portion of the microstructure.

6. The light guide plate as claimed in claim 1, wherein a bottom portion of the protective structure layer and a top portion of the microstructure have a gap formed therebetween.

7. A backlight module comprising:
a back plate;
a reflective sheet, disposed on the back plate;
a light guide plate, disposed on the reflective sheet;
a backlight source, disposed at a side of the light guide plate;
an optical film set, disposed on the light guide plate;
wherein the light guide plate has a light output surface, the light output surface is disposed with a microstructure, a protective structure layer is disposed overlying the microstructure, the protective structure layer and the microstructure are integrally formed in the light guide plate.

8. The backlight module as claimed in claim 7, wherein the microstructure comprises a plurality of triangular prisms.

9. The backlight module as claimed in claim 7, wherein the microstructure comprises a plurality of semi-cylinders.

10. The backlight module as claimed in claim 7, wherein the microstructure comprises a plurality of micro-bumps.

11. The backlight module as claimed in claim 7, wherein a bottom portion of the protective structure layer is tightly contacted with a top portion of the microstructure.

12. The backlight module as claimed in claim 7, wherein a bottom portion of the protective structure layer and a top portion of the microstructure have a gap formed therebetween.

13. A liquid crystal display device comprising a liquid crystal panel and a backlight module, the liquid crystal panel and the backlight module being disposed opposite to each other, the backlight module being configured for providing a display light source to the liquid crystal panel to facilitate the liquid crystal panel to display an image; the backlight module comprising:
a back plate;
a reflective sheet, disposed on the back plate;
a light guide plate, disposed on the reflective sheet;
a backlight source, disposed at a side of the light guide plate;
an optical film set, disposed on the light guide plate;
wherein the light guide plate has a light output surface, the light output surface is disposed with a microstructure, a protective structure layer is disposed overlying the microstructure, the protective structure layer and the microstructure are integrally formed in the light guide plate.

14. The liquid crystal display device as claimed in claim 13, wherein the microstructure comprises a plurality of triangular prisms.

15. The liquid crystal display device as claimed in claim 13, wherein the microstructure comprises a plurality of semi-cylinders.

16. The liquid crystal display device as claimed in claim 13, wherein the microstructure comprises a plurality of micro-bumps.

17. The liquid crystal display device as claimed in claim 13, wherein a bottom portion of the protective structure layer is tightly contacted with a top portion of the microstructure.

18. The liquid crystal display device as claimed in claim 13, wherein a bottom portion of the protective structure layer and a top portion of the microstructure have a gap formed therebetween.
